(19) United States
(12) Patent Application Publication
(10) Pub. No.: US 2024/0274873 A1
(43) Pub. Date: Aug. 15, 2024

(54) MULTIFUNCTIONAL INTERFACIAL LAYER AND COMPOSITE MEMBRANE AND SOLID-STATE BATTERY USING THE SAME

(71) Applicant: Academia Sinica, Taipei City (TW)

(72) Inventors: Hsiao-Hua YU, Taipei (TW); Baskar SELVARAJ, Taipei (TW)

(21) Appl. No.: 18/433,004

(22) Filed: Feb. 5, 2024

Related U.S. Application Data
(60) Provisional application No. 63/484,139, filed on Feb. 9, 2023.

(51) Int. Cl. H01M 10/0565; H01M 50/426; H01M 50/449; H01M 50/497

(52) U.S. Cl. CPC H01M 10/0565; H01M 50/426; H01M 50/449; H01M 50/497

(57) ABSTRACT

Disclosed is a multifunctional interfacial layer, which includes a conducting fiber network and a polymer-based conductive medium. The conducting fiber network layer can serves as a physical barrier to contain lithium dendrites and provide mechanical strength. The polymer-based conductive medium can facilitate smooth contact with electrodes. Under thermal treatment, an interface additive included in the polymer-based conductive medium can diffuse to the surface of the electrode, resulting in formation of an in-situ interfacial layer on the electrode. Accordingly, the multifunctional interfacial layer can resolve the problems of poor mechanical property and chemical instability at elevated potential and temperature associated with PEO-succinonitrile solid polymer electrolyte and prevent dendritic growth of lithium anode.

### CROSS REFERENCE TO RELATED APPLICATION

This application claims the benefit of the filing date of U.S. Provisional Application Ser. No. 63/484,139 filed Feb. 9, 2023. The entirety of said Provisional application is incorporated herein by reference.

### FIELD OF THE INVENTION

The present invention relates to a multifunctional interfacial layer and, more particularly, to a polymer-based multifunctional interfacial layer and a composite membrane and a solid-state battery using the same.

### DESCRIPTION OF RELATED ART

Batteries played a vital role during the digital transformation in the past decades. Similarly, it is now assuming the most significant importance for fossil fuel to electric vehicle transformation. High energy density and safety are crucial requirements to achieve this transformation, as the vehicles must travel long distances, and the battery size increases accordingly. A viable, practical solution to the capacity and safety problem is to replace the current low-capacity graphite (372 mAh g⁻¹) anode with high-capacity lithium metal (3860 mAh g⁻¹) and flammable liquid electrolyte with thermally stable solid electrolytes. Ceramics are an excellent candidate for the solid-electrolyte to replace the liquid with the required conductivity at room temperature (10⁻⁴˜10⁻³ S cm⁻¹) and mechanical strength to suppress the dendrite formation associated with lithium anode. Unfortunately, they have poor mechanical properties for device integration, incompatible at electrode and electrolyte interface, and expensive to produce on a large scale. Polymers such as polyethylene oxide (PEO) are devoid of these problems, but their conductivity is low at room temperature (10⁻⁸˜10⁻⁵ S cm⁻¹).

Composites of polymers and ceramics naturally evolved that complement each other to circumvent their disadvantages. However, adding polymer would compromise the ceramics' mechanical properties, which is essential for dendrite suppression. In addition, cost-effectiveness and interfacial compatibility problems remain.

Alternative to the ceramic filler addition, PEO crystallinity is reduced by adding plastic crystal material succinonitrile (SN) with the SN:EO ratio of 1:6 to improve conductivity to the required level of 10⁻⁴ S cm⁻¹ at room temperature. Although this polymer system is cheaper to produce, flexible to make good contact with the electrode, and easy for device integration than ceramics, it lacks the mechanical property to address the dendrite problem. Further, the corrosive reaction of SN polymerization with Li anode is making the interfacial problem even worse with increased interfacial resistance. Adding fluoroethylene carbonate (FEC) to the SN electrolyte can resolve this problem by forming a smooth LiF interfacial layer on the lithium anode. Though FEC addition can resolve the interfacial problem, the presence of liquid further aggravates the mechanical issue. The SN-based liquid electrolyte is cross-linked inside the glass-fiber skeleton to address this mechanical issue. However, the glass fiber is inert, and this method involves complex chemical reactions to create a gel electrolyte-like system. Also, it is inconceivable to add liquid into the solid electrolyte while striving to move away from it. Electrospinning of polyvinylidene fluoride (PVDF) fiber forms a porous network, which was integrated with PEO/Li_{6.5}La₃Zr_{1.5}Ta_{0.5}O₁₂ composite electrolyte increased the mechanical property of solid polymer electrolyte and superior in dendrite suppression capability. Also, porous ceramics polymer scaffold was reported to provide a similar backbone to sand-witch the polymer electrolytes with improved safety. Incorporating these fiber networks with the PEO-SN system certainly addresses the mechanical property issue. Nevertheless, these PVDF polymer and clay ceramics are non-conductive materials, and their presence in the solid electrolyte hinders lithium conduction despite their effectiveness in improving mechanical properties and safety.

### SUMMARY OF THE INVENTION

An objective of the present invention is to provide an innovative multifunctional interfacial layer that promotes the attainment of the desired conductivity, mechanical properties, and interfacial compatibility necessary for a solid electrolyte.

In accordance with the foregoing and other objectives, one aspect of the disclosure provides a multifunctional interfacial layer, which includes a conducting fiber network and a polymer-based conductive medium. The conducting fiber network can serve as a physical barrier to contain lithium dendrites and provide mechanical strength to prepare a thin solid polymer electrolyte membrane. In particular, the conducting fiber network can act as a host for the polymer-based conductive medium and an electrolyte layer without hindering lithium conduction different from inert fibers used in conventional art. The polymer-based conductive medium contains an interface additive therein and serves as a conductive gel infused into porous areas of the conducting fiber network. Heat-treatment of this solid polymer electrolyte membrane inclusive of the multifunctional interfacial layer can form an in-situ interfacial layer and enhance mixing of polymer electrolytes. Accordingly, the conducting fiber network filled with the polymer electrolytes and the in-situ formed interfacial layer can provide ionic conductive interface and suppress the chemical reaction between electrode and electrolyte.

Another aspect of the disclosure provides a composite membrane, which includes a first multifunctional interfacial layer and a plasticizer-containing electrolyte. As mentioned above, the first multifunctional interfacial layer includes a first conducting fiber network and a first polymer-based conductive medium that contains a first interface additive therein and serves as a first conductive gel. The first polymer-based conductive medium is infused into porous areas of the first conducting fiber network from a first side of the first conducting fiber network, while the plasticizer-containing electrolyte is combined with the first conducting fiber network from a second side of the first conducting fiber network opposite to the first side. Optionally, the composite membrane may further include a second multifunctional interfacial layer, which includes a second conducting fiber network and a second polymer-based conductive medium. As mentioned above, the second multifunctional interfacial layer includes a second conducting fiber network and a second polymer-based conductive medium that contains a second interface additive therein and serves as a second conductive gel. The plasticizer-containing electrolyte is combined with the second conducting fiber network from a first side of the second conducting fiber network, while the second polymer-based conductive medium is infused into porous areas of the second conducting fiber network from a second side of the second conducting fiber network opposite to the first side.

Yet another aspect of the disclosure provides a solid-state battery, which includes: a first electrode; a second electrode; and the above-mentioned composite membrane sandwiched between the first electrode and the second electrode. The plasticizer-containing electrolyte can be spaced from the first electrode by the first multifunctional interfacial layer adjacent to the first electrode and from the second electrode by the second multifunctional interfacial layer (if present) adjacent to the second electrode. The first and second multifunctional interfacial layers can facilitate smooth contact with the first and second electrodes, respectively. By thermal and potential treatment, the first interface additive included in the first polymer-based conductive medium can diffuse from the first polymer-based conductive medium to form a first in-situ interfacial layer between the first electrode and the first polymer-based conductive medium. Likewise, the second interface additive included in the second polymer-based conductive medium can diffuse from the second polymer-based conductive medium to form a second in-situ interfacial layer between the second electrode and the second polymer-based conductive medium.

In the present invention, the first conducting fiber network can include a first conductive polymer and first stiffeners as constituents thereof, while the second conducting fiber network can include a second conductive polymer and second stiffeners as constituents thereof. The first conducting fiber network and the second conducting fiber network may have the same or different thickness and each may be a porous net with a diameter of ˜100-200 nm and a thickness of from 0.1 to 10 μm. The conducting fiber network imparts freestanding properties to the membrane, enhancing its mechanical strength and contributing to the reduction of membrane thickness.

The first conductive polymer and the second conductive polymer can be the same or different in composition and have ionic conductivity. Preferably, the first conductive polymer and the second conductive polymer have ionic-electric dual-conductivity. For instance, in one or more embodiments of the present invention, each of the first conductive polymer and the second conductive polymer includes an ionic-electric dual-conductive polymer and an ionic conductive polymer. The first stiffeners and the second stiffeners can be the same or different and may be of any material favorable for enhancement in a mechanical strength of the conducting fiber network. Furthermore, the first conducting fiber network and the second conducting fiber network can further include a first binder and a second binder, respectively. Examples of the ionic-electric dual-conductive polymer for the conducting fiber network include, but are not limited to, poly(3,4-ethylenedioxythiophene) polystyrene sulfonate (PEDOT:PSS) copolymer and the like. Examples of the ionic conductive polymer for the conducting fiber network include, but are not limited to, PEO polymer, a PVDF polymer, a combination thereof and the like. Examples of the first stiffeners and the second stiffeners include, but are not limited to, multi-walled carbon nanotubes and the like.

In the present invention, the first polymer-based conductive medium and the second polymer-based conductive medium can be the same or different in composition and thickness, and each may include an ionic conductive polymer and lithium salts. The thickness of the polymer-based conductive medium can range from 0.01 to 5 μm. For instance, in one or more embodiments of the present invention, the polymer-based conductive medium is formed in a thickness (e.g. ˜0.5 μm) less than that of the conducting fiber network (e.g. ˜0.1 to 2 μm). The ionic conductive polymer for the polymer-based conductive medium can be anyone with compatibility with the conducting fiber network and the electrolyte. Examples of the ionic conductive polymer for the polymer-based conductive medium include, but are not limited to, PEO polymer, a PVDF polymer, a combination thereof and the like. Examples of the lithium salts for the polymer-based conductive medium include, but are not limited to, LiClO₄, lithium bis(trifluoromethane sulfonyl)imide (LITFSI), a combination thereof and the like.

In the present invention, the first interface additive and the second interface additive can be the same or different and may be anyone capable of diffusing from the polymer-based conductive medium to the first and second electrodes and forming the first and second in-situ interfacial layers, respectively. The first and second in-situ interfacial layers can be formed by oxidation of the first and second interface additives, respectively. Examples of the interface additive include, but are not limited to, fluoroethylene carbonate (FEC), ethylene carbonate (EC), propylene carbonate (PC), a combination thereof and the like.

In the present invention, the plasticizer-containing electrolyte can have any suitable thickness and include a solid-state electrolyte matrix and a plasticizer in the solid-state electrolyte matrix. For instance, in one or more embodiments of the present invention, the thickness of the plasticizer-containing electrolyte is adjusted to control the composite membrane in a thickness of 50-100 μm. The solid-state electrolyte matrix can include an ionic conductive polymer and lithium salts. Examples of the ionic conductive polymer for the solid-state electrolyte matrix include, but are not limited to, PEO polymer, a PVDF polymer, a combination thereof and the like. Examples of the lithium salts for the solid-state electrolyte matrix include, but are not limited to, LiClO₄, lithium bis(trifluoromethanesulfonyl) imide (LITFSI), a combination thereof and the like. Examples of the plasticizer include, but are not limited to, succinonitrile and the like.

In the present invention, the composite membrane integrated with a lithium iron phosphate cathode or a lithium titanium oxide cathode as one of the first and second electrodes paired with a lithium anode as the other of the first and second electrodes can exhibit remarkable stability at higher and room temperatures, demonstrating its potential for practical application.

These and other features and advantages of the present invention will be further described and more readily apparent from the detailed description of the preferred embodiments which follows.

### BRIEF DESCRIPTION OF THE DRAWINGS

FIG. 1 shows a schematic depiction of the preparation of a multi-functional interfacial layer (a) and operating mechanism of MFI-PEO-SN electrolyte (b).

FIG. 2 shows a cross-sectional schematic view of a solid-state battery with a one-sided interfacial layer before thermal and potential treatment.

FIG. 3 shows a cross-sectional schematic view of the solid-state battery of FIG. 2 after thermal and potential treatment.

FIG. 4 shows a cross-sectional schematic view of a solid-state battery with double-sided interfacial layers before thermal and potential treatment.

FIG. 5 shows a cross-sectional schematic view of the solid-state battery of FIG. 4 after thermal and potential treatment.

FIG. 6 shows photographs of SEM images of membrane with SN:EO ratio 1:6 (a, c) and 1:5 (b, d).

FIG. 7 shows photographs, SEM, and cross section images of nanofibrous mat layer (a, e, i), polymer gel layer (b, f, j), combined layer of multi-functional interfacial layer (c, g, k), and interfacial layer combined with solid polymer electrolyte layer (d, h, l).

FIG. 8 shows Nyquist plots of 15 minutes PFG (a) 10 minutes NFG (b) 10 minutes (c) and 15 minutes (d) MFI layers coated PEO-SN membranes.

FIG. 9 shows stress-strain curves of pristine solid polymer membrane, one-side of membrane coated with MFI layer and both-sides of membrane coated with MFI layers.

FIG. 10 shows linear sweep voltammograms (LSV) of coin cells made with membranes and lithium electrode paired with stainless steel (a), LTO, and NCM electrodes (b) at various temperatures, and impedance spectra of membranes paired with stainless steel before (c,e) and after (d,f) 60° C. cell operation measured at room temperature.

FIG. 11 shows critical current density measurements of membranes with lithium symmetric cells at 40° C. (a) and 30° C. (b).

FIG. 12 shows charge-discharge profile, rate, and cycling performance of LTO @ 55° C. (a, d) and LFP @ 55° C. (b, e) and @ room temperature (RT) (c, f).

FIG. 13 shows electrochemical performance measurements for 300 cycles at 40° C. (a) and 175 cycles at 30° C. (b).

### DETAILED DESCRIPTION OF THE PREFERRED EMBODIMENTS

In order to resolve the interfacial and mechanical problems, a conducting fiber network is developed, and an interface additive is incorporated innovatively to form an in-situ thin layer on an electrode. Specifically, the conducting fiber network can include a conductive polymer and stiffeners, and a polymer-based conductive medium containing the interface additive can be infused into porous areas of the first conducting fiber network to form a multifunctional interfacial layer.

### Abbreviations

NFM nanofibrous membrane
MFI multifunctional interfacial
PEO polyethylene oxide
PVDF polyvinylidene fluoride
PEDOT: PSS poly(3,4-ethylenedioxythiophene) polystyrene sulfonate
MWCNT multi-walled carbon nanotube
FEC fluoroethylene carbonate
EC ethylene carbonate
PC propylene carbonate
LITFSI lithium bis(trifluoromethanesulfonyl) imide
SN succinonitrile
LTO lithium titanium oxide
LFP lithium iron phosphate
NCM nickel cobalt manganese oxide

### MFI Layer, Composite Membrane and Solid-State Battery

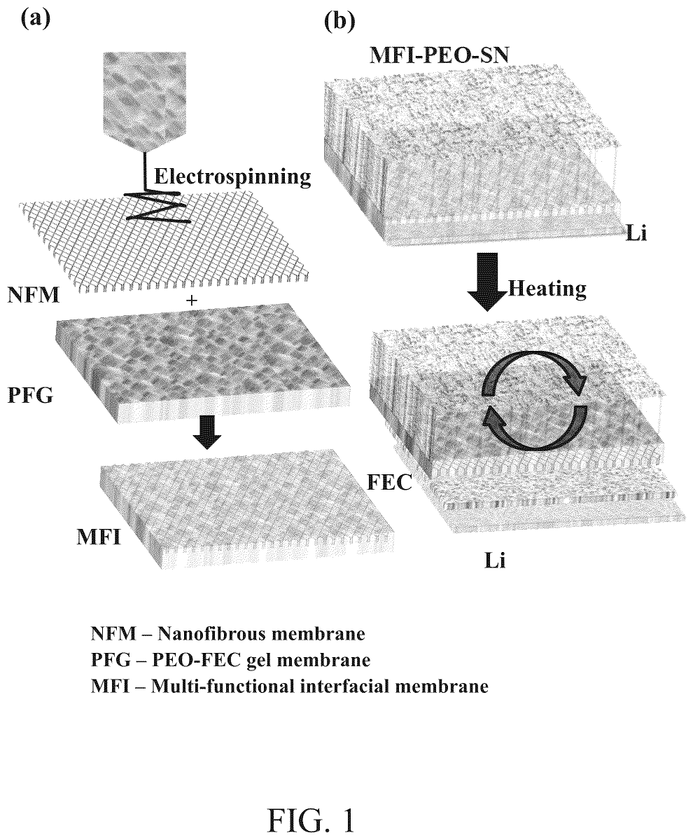

FIG. 1(a) depicts a schematic view of the preparation of a MFI layer in accordance with one embodiment. First, a porous nanofibrous mat (NFM layer) can be formed as the conducting fiber network by, for example, electrospinning of a first solution containing a conductive polymer and stiffeners. In the preparation of the first solution, an ionic conductive polymer (such as PEO polymer, a PVDF polymer, a combination thereof or others) is added to an ionic-electric dual-conductive polymer (such as PEDOT: PSS or others) solution to improve its ionic conductivity and decrease its electronic conductivity due to the ionic conductive polymer addition, compensated with the stiffeners (such as multi-walled carbon nanotube, MWCNT, or others) addition. Furthermore, a binder (such as (3-glycidyloxy propyl)-trimethoxysilane or others) can be included in the first solution to facilitate the binding of the ionic conductive polymer and the ionic-electric dual-conductive polymer. Additionally, it contributes to providing sufficient viscosity to the first solution for effective electrospinning. Next, a second solution, containing an ionic conductive polymer (such as PEO polymer, a PVDF polymer, a combination thereof or others), an interface additive (such as fluoroethylene carbonate (FEC), ethylene carbonate (EC), propylene carbonate (PC), a combination thereof or others) and lithium salts (such as LiClO₄, lithium bis(trifluoromethanesulfonyl) imide (LITFSI), a combination thereof or others), is electrosprayed on the nanofibrous mat to form a polymer-based conductive medium infused into the mat through the capillary action and covered the porous area. In this illustration, PEO polymer and FEC are used as the ionic conductive polymer and the interface additive, respectively, and the polymer-based conductive medium is a thin PEO-FEC gel layer (PFG layer). Finally, on top of this, a plasticizer-containing electrolyte, containing a solid-state electrolyte matrix (such as PEO or others) and a plasticizer (such as SN or others) in the solid-state electrolyte matrix, is spread to form all polymer solid-electrolyte composite membranes (MFI-PEO-SN), as shown in FIG. 1(b). The composite membrane combined with lithium anode is heated to diffuse FEC molecules (i.e. the interface additive) to the surface of the electrode to form LiF layer, while PEO and Li salts trapped within the mat mixed with PEO-SN polymer electrolyte. Nanofibrous mat filled with polymer electrolyte in contact with the in-situ formed interfacial layer provides the ionic conductive interface and suppresses the chemical reactions between electrode and electrolyte and improves the mechanical property of the membrane.

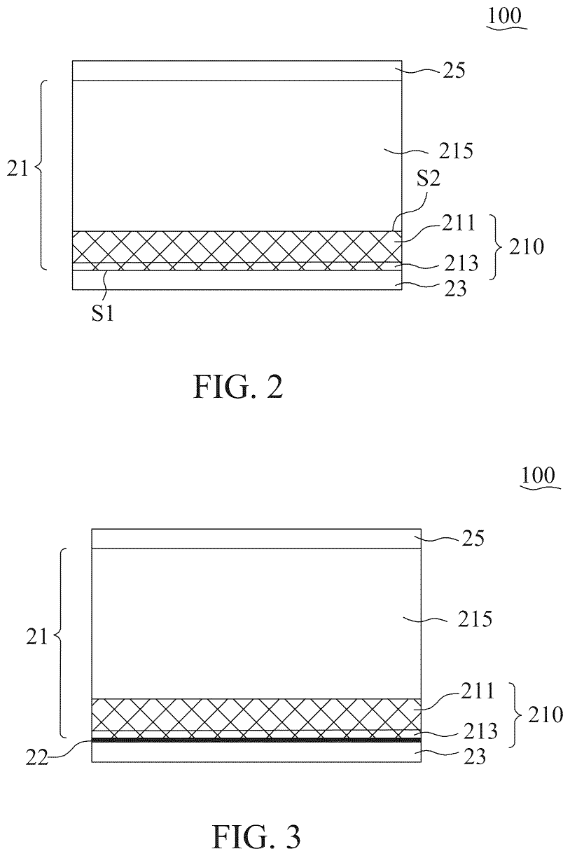

Also disclosed herein are solid-state batteries featuring a one-sided interfacial layer or double-sided interfacial layers. As shown in FIG. 2, in a solid-state battery 100 with a one-sided interfacial layer, the composite membrane 21, sandwiched between the first electrode 23 and the second electrode 25, includes a first multifunctional interfacial layer 210 and a plasticizer-containing electrolyte 215 spaced from the first electrode 23 by the first multifunctional interfacial layer 210. As mentioned above, the first multifunctional interfacial layer 210 includes a first conducting fiber network 211 and a first polymer-based conductive medium 213. The first polymer-based conductive medium 213 is a first conductive gel infused into porous areas of the first conducting fiber network 211 from a first side S1 of the first conducting fiber network 211 and adjacent to the first electrode 23, while the plasticizer-containing electrolyte 215 is combined with the first conducting fiber network from a second side S2 (opposite to the first side S1) of the first conducting fiber network 211 and spaced from the first electrode 23 by the first multifunctional interfacial layer 210. Under thermal and potential treatment, the first interface additive included in the first polymer-based conductive medium 213 can diffuse to the surface of the first electrode 23 and is oxidized to from a first in-situ interfacial layer 22 between the first electrode 23 and the first polymer-based conductive medium 213, as show in FIG. 3. After the formation of the first in-situ interfacial layer 22 by one part of the first interface additive diffused from the first polymer-based conductive medium 213, the first polymer-based conductive medium 213 may contain a retained part of the first interface additive therein and be in a solid state or partially in a gel state.

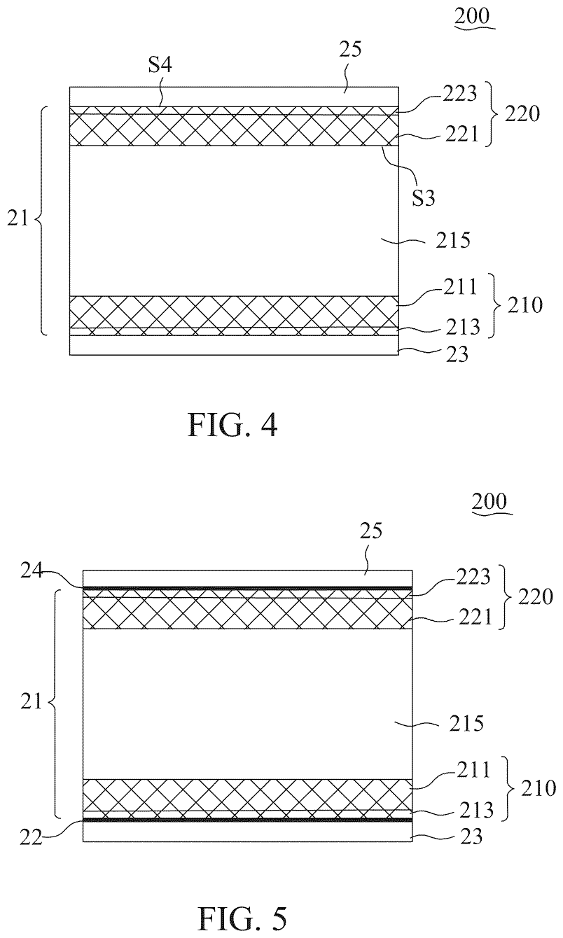

As another embodiment, a solid-state battery 200 with double-sided interfacial layers is shown in FIG. 4, which is similar to that illustrated in FIG. 2, except it further includes a second multifunctional interfacial layer 220 by which the plasticizer-containing electrolyte 215 is spaced from the second electrode 25. Likewise, the second multifunctional interfacial layer 220 includes a second conducting fiber network 221 and a second polymer-based conductive medium 223. The plasticizer-containing electrolyte 215 is combined with the second conducting fiber network from a first side S3 of the second conducting fiber network 221, while the second polymer-based conductive medium 223 is a second conductive gel infused into porous areas of the second conducting fiber network 221 from a second side S4 (opposite to the first side S3) of the second conducting fiber network 221 and adjacent to the second electrode 25. Under thermal and potential treatment, the first and second interface additives included in the first and second polymer-based conductive mediums 213 and 223, respectively, can diffuse to the surfaces of the first and second electrodes 23 and 25, respectively, and are oxidized o from a first in-situ interfacial layer 22 between the first electrode 23 and the first polymer-based conductive medium 213 and a second in-situ interfacial layer 24 between the second electrode 25 and the second polymer-based conductive medium 223, as show in FIG. 5. After the formation of the first/second in-situ interfacial layer 22/24 by one part of the first/second interface additive diffused from the first/second polymer-based conductive medium 213/223, the first/second polymer-based conductive medium 213/223 may contain a retained part of the first/second interface additive therein and be in a solid state or partially in a gel state.

In the above-mentioned first and second multifunctional interfacial layers, each of the first and second conducting fiber networks can have a thickness of from 0.1 to 10 μm, and each of the first and second polymer-based conductive mediums can have a thickness of from 0.01 to 5 μm.

### Experimental Details

### [Formation of Nanofibrous Mat (NFM) Layer]

The dual conductive PEDOT: PSS/PEO/MWCNT nanofiber mat, prepared from a quaternary blend solution of MWCNTs, PEDOT: PSS aqueous solution, PEO, and (3-glycidyloxypropyl)-trimethoxysilane were deposited through needle-type electrospinning. It was performed using a 23-gauge disposable needle with a flow rate of 2 mL h⁻¹ and a voltage supply of 29 kV. The distance between the needle and collector was 11 cm and the deposition time varied to obtain the required mat thickness. Fibers were electrospun in an atmosphere of air for 10 min at ambient temperature under a relative humidity of less than 45%.

### [Preparation of MFI-PEO-SN Solid-Polymer Electrolyte]

PEO with a molecular weight of 300,000 was added along with LiClO₄ salt in acetonitrile. After adding FEC to this solution to obtain the target mole ratio of PEO:LiClO₄:FEC 10:1:6, it was sealed and stirred overnight. Electrospraying of the solution was performed using a 27-gauge disposable needle with a flow rate of 3 mL h⁻¹ and a voltage supply of 29 kV. Teflon collector coated with fiber was placed on the rotating drum rotating at 50 rpm. The distance between the needle and collector kept 7.5 cm and the spraying time varied to adjust the thickness of the gel layer to obtain the multi-functional interfacial layer. PEO, SN, and LiClO₄ were added to acetonitrile with varied molar ratios mixed thoroughly before evenly spread on the teflon sheet coated with multi-functional interfacial layer using doctor blade and dried at 50° C. for 48 hours under vacuum to obtain MFI-PEO-SN solid-electrolyte membrane. For control samples, PEO-SN electrolyte was spread on nanofibrous mat layer (NFM-PEO-SN) and electrosprayed gel layer (PFG-PEO-SN).

### [Characterization and Coin Cell Assembly]

The structure and morphology of the materials were examined using a scanning electron microscope (SEM; JEOL JSM-7600F) equipped with an energy dispersive X-ray spectroscopy (EDS, X-MaxN, Oxford Instruments). Electrodes were prepared by mixing lithium titanium oxide (LTO), lithium iron phosphate (LFP) and nickel cobalt manganese oxide (NCM) powders with Super P and 5% PVDF with the weight ratio of 80:10:10 and casting onto an Al current collector. Coin cells (2032) were assembled in a glove box by placing the MFI-PEO-SN membrane between the Li anode and LFP cathode. The electrochemical performance of the cells was measured using a CHI workstation and Arbin battery test station (BT-2000, model: MCN6410) at various current densities, applied voltages range, and operating temperatures. Impedance tests were conducted on a potentiostat (Biologic, SP 300) in the frequency range from 7 m to 1 Hz with an amplitude of 10 mV with stainless steel as the blocking electrode. The conductivity was calculated based on the equation:

$$R = ρ \frac{l}{A}$$

Where l is the thickness of the solid electrolytes, R is the impedance read from the real axis in the Nyquist plot, p is the conductivity and A is the surface area.

### Results and Discussion

### [Relationship Between SN Content, Conductivity, and Temperature]

TABLE 1
Conductivity of the PEO—SN membranes.

| | Conductivity | | | After 80° C. |
|---|---|---|---|---|
| PEO:SN:LiClO₄ | (S/cm) | | | Measurement |
| Molar ratio | @30° C. | @45° C. | @80° C. | @30° C. |
| 18:3:1 | 3.21 × 10⁻⁵ | 2.75 × 10⁻⁴ | 1.07 × 10⁻³ | 5.95 × 10⁻⁵ |
| 10:1:1 | 2.96 × 10⁻⁵ | 2.17 × 10⁻⁴ | 1.26 × 10⁻³ | 5.67 × 10⁻⁵ |
| 10:2:1 | 2.36 × 10⁻⁴ | 6.68 × 10⁻⁴ | 1.9 × 10⁻³ | 6.75 × 10⁻⁴ |

A free-standing membrane construction was reported with required conductivity in the order of 10⁻⁴ when SN:EO ratio increased to more than 1:6. The key to having free-standing film even at high SN concentration was to reduce Li⁺:EO concentration to 1:32. Herein, relatively less hygroscopic lithium perchlorate salt was chosen for membrane preparation. As this work aims to resolve the interfacial problem and mechanical property, Li⁺:EO concentration was kept high while maintaining SN:EO ratio above and below the reported 1:6 threshold. The conductivity of the membranes remained in the order of 10⁻⁵ irrespective of the change in Li⁺:EO ratio of 1:18 and 1:10. Conductivity rapidly increased an order of 10⁻⁴ when SN:EO ratio crossed the reported 1:6 threshold. This result validated that LiClO₄ salt did not cause any significant change and confirmed that SN:EO is the deciding factor.

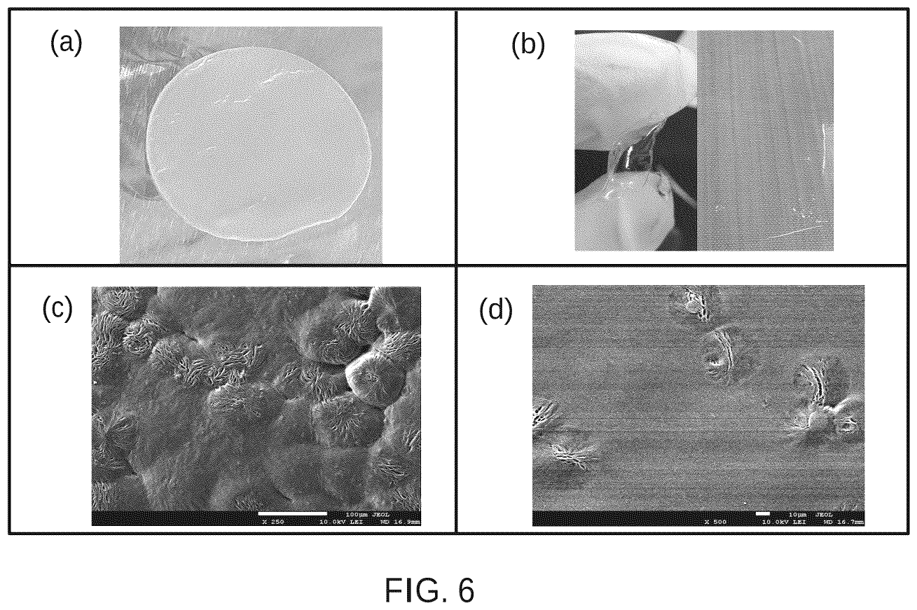

It was observed that the membrane's conductivity significantly varied after measurements involved >50° C. for all the samples, irrespective of the SN and salt content. The appearance of less SN-containing samples was slightly white and easily processable, while high SN:EO membranes were transparent and sticky (FIG. 6a, c). SEM analysis of these membranes showed an amorphous featureless surface. However, many PEO crystalline domains were observed for the SN:EO 1:6 ratio sample, which was relatively less in the 1:5 membrane (FIG. 6b, d). This observation concurs with the report that SN content should be increased to have a mixed homogeneous phase necessary for fast Li⁺ transport. However, the presence of crystalline domain even for high SN-containing samples indicated a problem obtaining homogenous mixing. The heating of the sample above the PEO melting point might have improved homogeneity and reduced contact resistance from the rough surface, which led to an overall increase in conductivity. This change after heat treatment implies that heating of the membrane helps to attain homogeneity, high SN content is necessary for high ionic conductivity, and useful to reduce electrode-electrolyte contact resistance but brought difficulty to processing the membranes.

### [Construction of MFI-PEO-SN all Polymer Solid-Electrolyte]

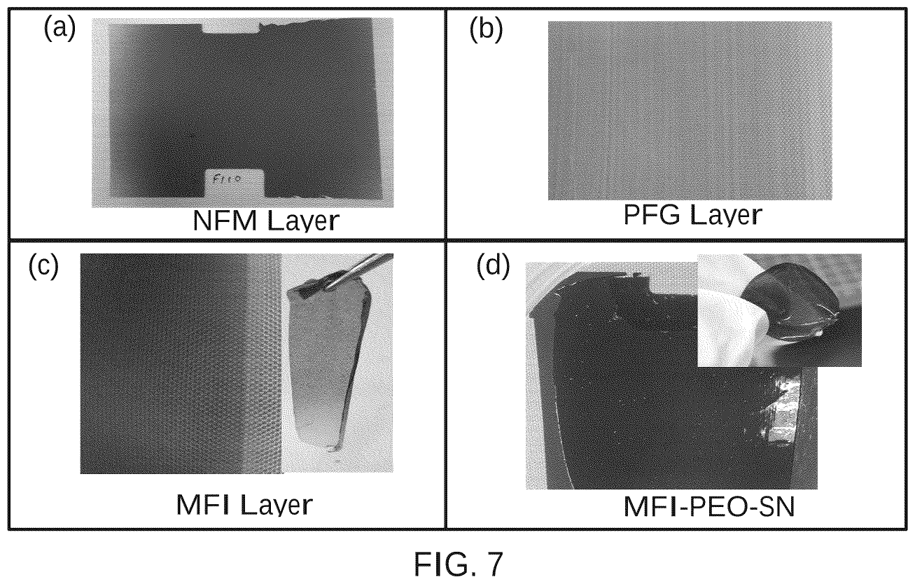

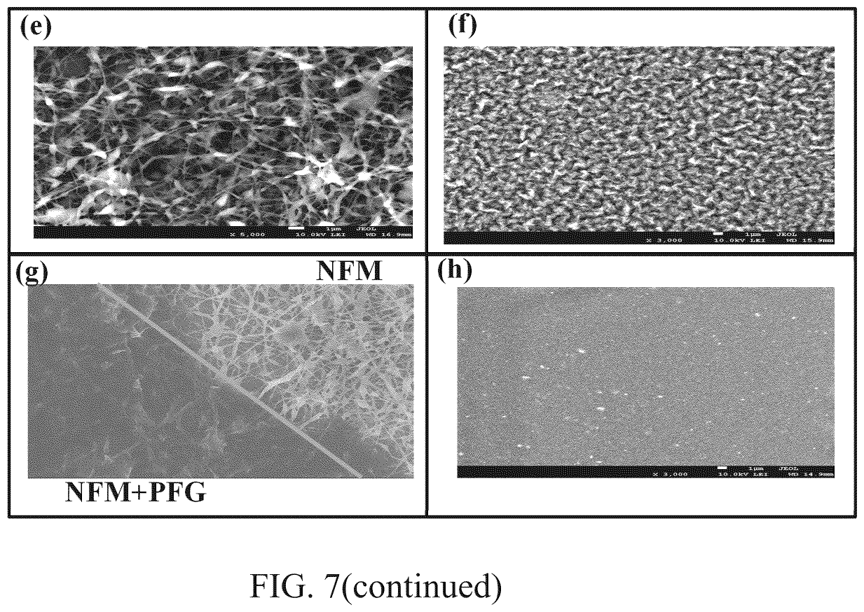

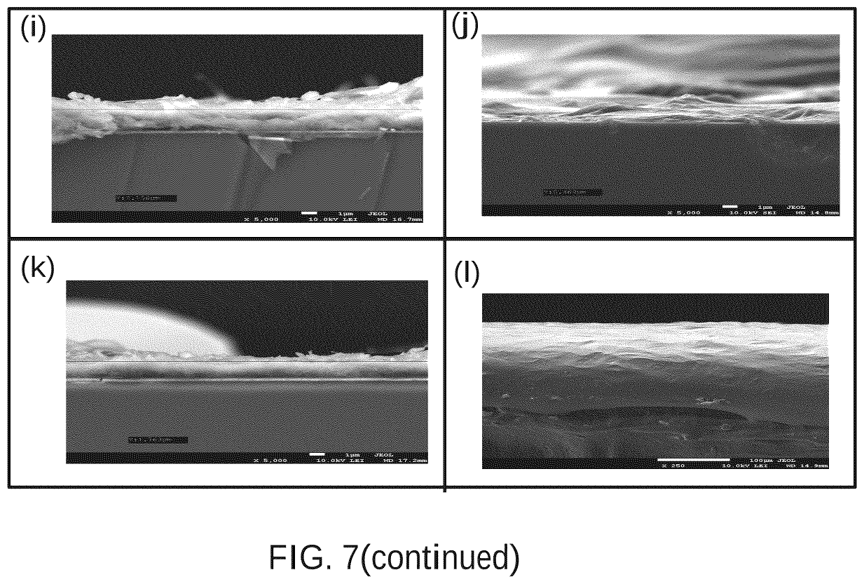

High SN content is necessary to increase conductivity and improve electrode-electrolyte contact. The following processability issue arises from the drop in mechanical strength to be addressed, which is also necessary to suppress dendrite formation. Electrospinning of PEDOT: formed uniform nanofibrous mat. Area coverage of this NFM layer can be varied from 1 cm×1 cm to 100 cm×100 cm by adjusting the spinning condition. The electrospinning time was varied to control the thickness of the layer. Electrospun fibers formed like a porous net with a diameter of ˜100-200 nm (FIG. 7e). A ten minutes electrospinning formed a ˜2 μm thick layer (FIG. 7f). Electrospraying of PEO:LiClO₄:FEC solution for 15 minutes formed white colored thin PFG layer (˜0.5 μm) with regularly arranged PEO crystalline structure (FIG. 7b, f, j). This crystallinity structure disappeared when sprayed on top of the fiber net. Infusion of the gel layer into the porous area through capillary action completely covered the fibers. The contrast can be seen from the single NFM layer and double NFM+PFG layers (FIG. 7g). Interestingly, mechanically strong fibrous net absorbed this gel layer and increased amorphisity of PEO, which is vital to increase the ionic conductivity of PEO polymer. Combining of NFM and PFG layer did not change the layer thickness as it was infused, not stacked together (FIG. 7k). Spreading of PEO-SN electrolyte on the MFI layer and drying gave MFI-PEO-SN all polymer solid electrolyte membrane. The thickness of the membrane was controlled between 50-100 μm by adjusting the PEO-SN coating layer. Unlike the pure PEO-SN membrane (FIG. 6b), this membrane is free-standing and easy to handle due to the underlying MFI supporting layer (FIG. 7d). Since the MFI-PEO-SN membrane is relatively thin, the underlying MFI layer made PEO-SN surface uneven and rough (FIG. 7h). It is to be noted here that reported free-standing membranes were made 150 μm thick understandably for the ease of processing and preventing lithium dendrite penetration through the membrane. Increasing membrane thickness to resolve this problem will decrease the cell's energy density. Instead, ˜2 μm thick MFI layer developed here provided strong mechanical strength to construct a processable thin free-standing all polymer solid-electrolyte membrane.

### [Conductivity, Mechanical Property and Operating Mechanism of MFI Layer]

TABLE 2
Conductivity of the interfacial layer coated membranes.

| Sample | | PFG | NFM | MFI | MFI |
|---|---|---|---|---|---|
| (SN:EO 1:5) | PEO—SN | 15 mins | 10 mins | 10 mins | 15 mins |
| Conductivity | 6.75 × 10⁻⁴ | 3.93 × 10⁻⁴ | 2.19 × 10⁻⁴ | 1.84 × 10⁻⁴ | 1.83 × 10⁻⁴ |
| S/cm @ 30° C. | | | | | |

The impact of the interfacial layer coating on conductivity was evaluated using PEO-SN membranes coated with single and double interfacial layers for 10-15 minutes. FEC containing PFG layer coated for 15 mins membrane had conductivity less than of PEO-SN electrolyte. Despite the presence of a liquid component in PFG, the observed regularly arranged PEO crystalline formation after spraying (FIG. 7f) would be the reason for this reduction, as the crystalline PEO is known for its low ionic conductivity. Nanofibrous NFM layer coated for 10 minutes membrane also showed lower conductivity like PFG coating, as it is an additional layer between electrolyte and electrode. The combined coating of these two layers for 10 minutes to form the MFI layer had conductivity close to that of the NFM-coated membrane but still lesser than the original PEO-SN electrolyte. Although the nanofibrous mat turned the PEO into amorphous (FIG. 7g), the conductivity was still lower than PFG, and NFM coated membranes since there were ˜1-2 μm thick two combined layers between the electrolyte and electrode to have a protective layer to prevent SN reaction with lithium metal as well as improve mechanical strength. Although the conductivity was reduced after interfacial layer coating on the PEO-SN electrolyte, the conductivity did not fall below the order of 10⁻⁴ necessary for cell operation. These results indicated that the ˜1-2 μm thick interfacial layers have enough ionic conductivity and did not prevent lithium-ion diffusion significantly.

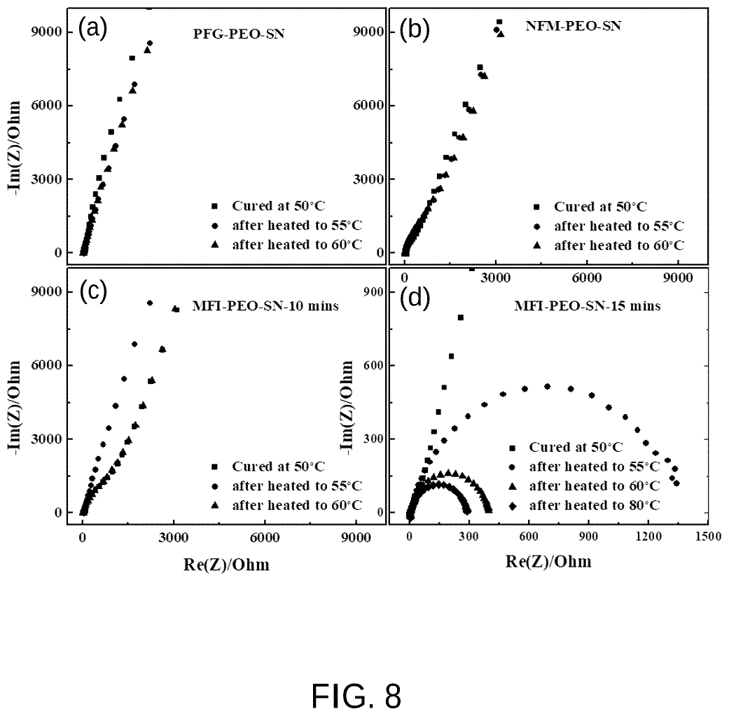

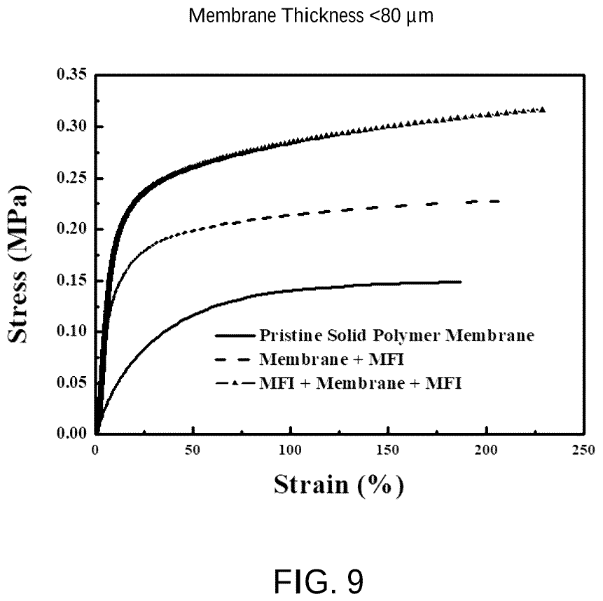

This perception drastically changed after the MFI layer coating time increased to 15 minutes. The conductivity dropped drastically by order (10⁻⁵). This unprecedented change was analyzed using impedance measurements by treating the cells at different temperatures. Nyquist plots of membranes coated with PFG, NFM, and MFI layers for a limited time, did not show any significant change before and after temperature treatment (FIG. 8a, b, c). A huge increase in resistivity was observed for the 15 minutes MFI layer coated sample when the cell was heated at 55° C. for 24 hours (FIG. 8d). Further increase in treatment temperature to 60° C. led to a decrease in resistance, and the decreasing pattern continued when the treating temperature increased to 80° C. A possible explanation for this phenomenon is that more FEC molecules diffuse away from the MFI layer when the membrane is heated above the membrane curing temperature of 50° C., causing the formation of a thick low conductive PEO layer filled within pores of the nanofibrous mat as neither PEO nor SN melts at 55° C. SN started to melt first when the temperature raised to 60° C. enabling a path for lithium diffusion and a further increase in temperature to 80° C. to melt PEO to mix with SN, ultimately reducing the resistance. These results indicate that prolonged treatment of membrane at <60° C. allow FEC molecules move towards electrode surface, temperature >65° C. treatment helps to mitigate the subsequent decrease in conductivity, a thin layer of MFI does not affect lithium diffusion significantly, and a thick layer of MFI is seriously hampering the lithium diffusion. Moreover, it was demonstrated that the implementation of a multifunctional bilayer interface leads to an enhancement in mechanical properties (FIG. 9).

### [Effectiveness of the Multi-Functional Interfacial Layer]

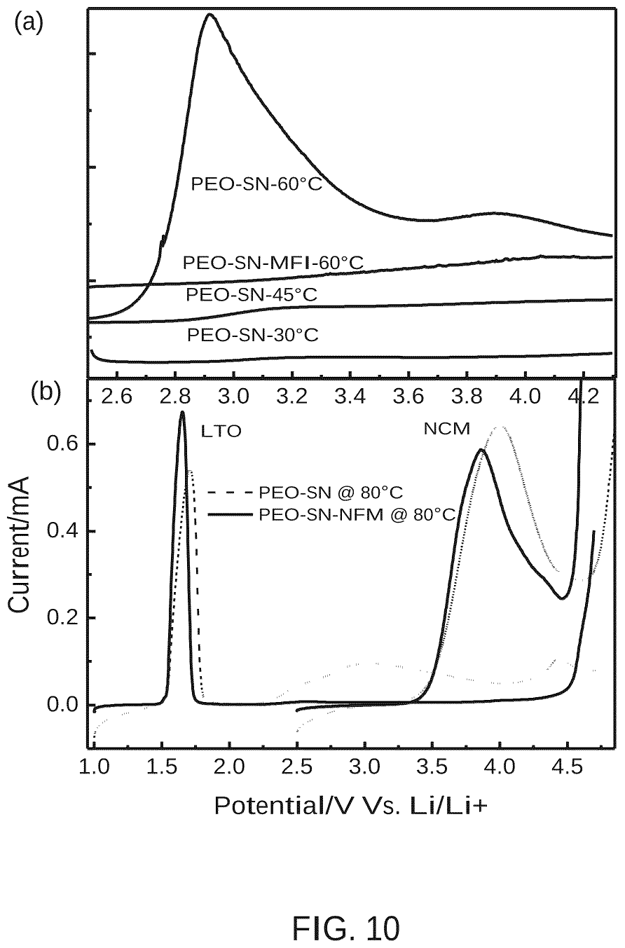

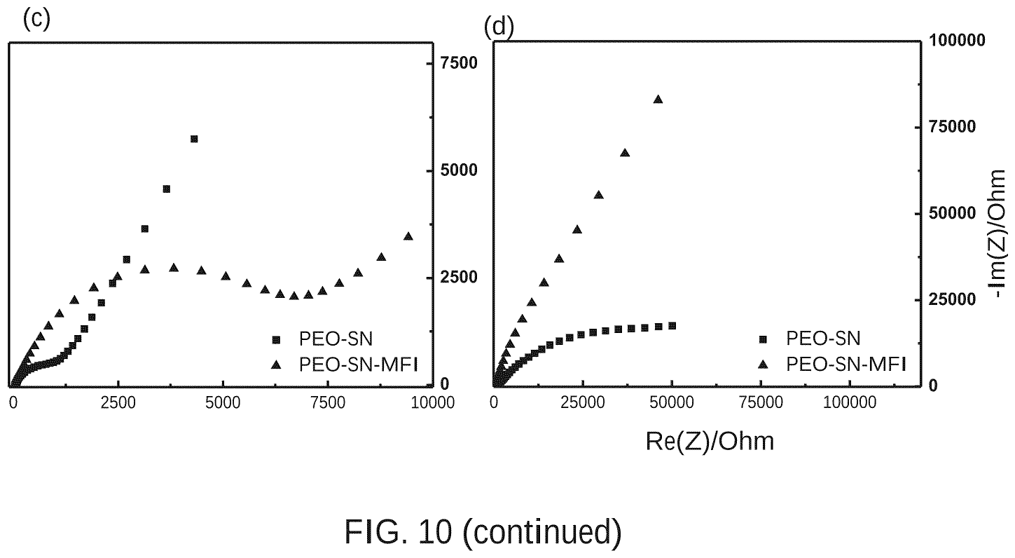

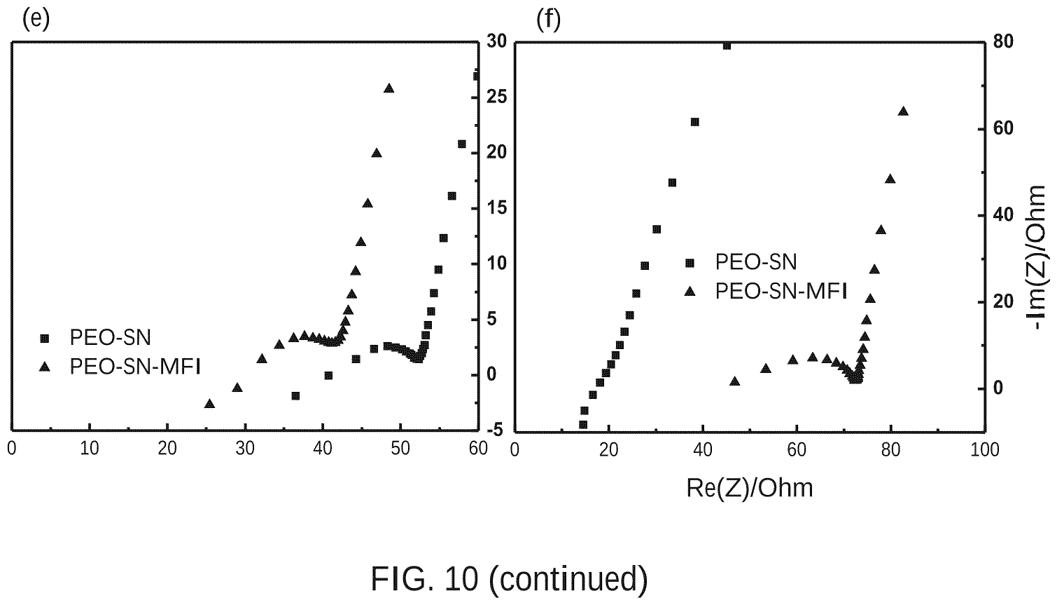

The nature of SN reaction with lithium and the effectiveness of the MFI layer in preventing this reaction was tested using coin cells made with polymer electrolyte membranes placed between stainless steel and a lithium anode. A small peak started to appear for the cell made with the PEO-SN membrane operated at 30° C. after 2.9 V, and the next change in current was observed after 4 V (FIG. 10a). The first peak is ascribed to SN reaction with the lithium, as the second peak is associated with the known PEO oxidation at a potential higher than 3.8V. The peak for the SN reaction increased with the cell operating temperature to 45° C., and a huge rise was observed at 60° C. (FIG. 10a). This exponential rise is due to the melting of SN at this temperature which brings more SN molecules to the lithium surface. Replacement of the PEO-SN membrane with the MFI-PEO-SN membrane leads to the complete disappearance of the peak even at 60° C., proving that the developed interfacial layer is highly effective in preventing the SN reaction with lithium. Impedance measurement showed high resistance for the cell made with MFI-PEO-SN membrane compared to PEO-SN membrane cell before LSV operation (FIG. 10c, e), which significantly reduced after 60° C. cell operation (FIG. 10d, f) with little increase in interfacial resistance (FIG. 10c, e, d, f). In contrast, a multi-fold increase in overall cell resistance was observed for the PEO-SN membrane after 60° C. cell operation due to severe corrosion caused by the SN reaction with lithium. The absence of the peak at ˜3 V for the MFI-PEO-SN membrane and reversal of impedance trend before and after heating to 60° C. proved that the MFI layer has effectively prevented SN reaction with lithium and reinforced the MFI operational mechanism explained in the previous section. In addition, it can be inferred from the observed temperature-dependent increase in peak current for SN reaction with PEO-SN membrane that this reaction is temperature dependent and progressive in nature.

The impact of the electrode material having varied working potential window was studied with LTO and NCM electrodes after three cycles at a harsh operating temperature of 80° C. to accelerate the SN reaction with lithium, as it is progressive (FIG. 10b). There was a slight increase in current with a tiny peak at 4.0 V observed for MFI-PEO-SN combined with lithium and stainless steel cell (FIG. 10a). It might be from either FEC reaction or PEO oxidation at the lithium electrode. To investigate this peak origination and the PFG layer's role in preventing SN reaction, the NFM-PEO-SN membrane was used instead of the MFI-PEO-SN membrane. LSV showed similar SN reaction and PEO oxidation peaks along with LTO's peak for the PEO-SN membrane combined with the LTO electrode. Membrane degradation became severe after 4.6 V with the NCM electrode. The peak responsible for SN reaction with lithium completely disappeared in LTO cells when PEO-SN was replaced with the NFM-PEO-SN membrane indicating that NFM alone could act as a protective layer to prevent SN reaction. This prevention of corrosive reaction was reflected in the appearance of sharp LTO and NCM peaks with reduced overpotential different from broader peaks with a shift in peak potential for these materials when combined with the PEO-SN membrane. Membrane degradation accelerated when the NCM electrode was used irrespective of the membrane since it is very active and reacts with PEO. Considering the proximity of PEO molecules to the lithium in the MFI layer where PFG is infused into it and the acceleration of membrane degradation due to the direct exposure of PEO-SN electrolyte to the NCM material, it can be concluded that PEO oxidation occurs at both anode and cathode at potential >3.8 V. However, it is pronounced when NCM materials used as the cathode. Therefore, this membrane is suitable to use from 1 V to 3.8 V, which can be extended further to >4.4 V if an additional protection layer is made to prevent PEO reaction with NCM material.

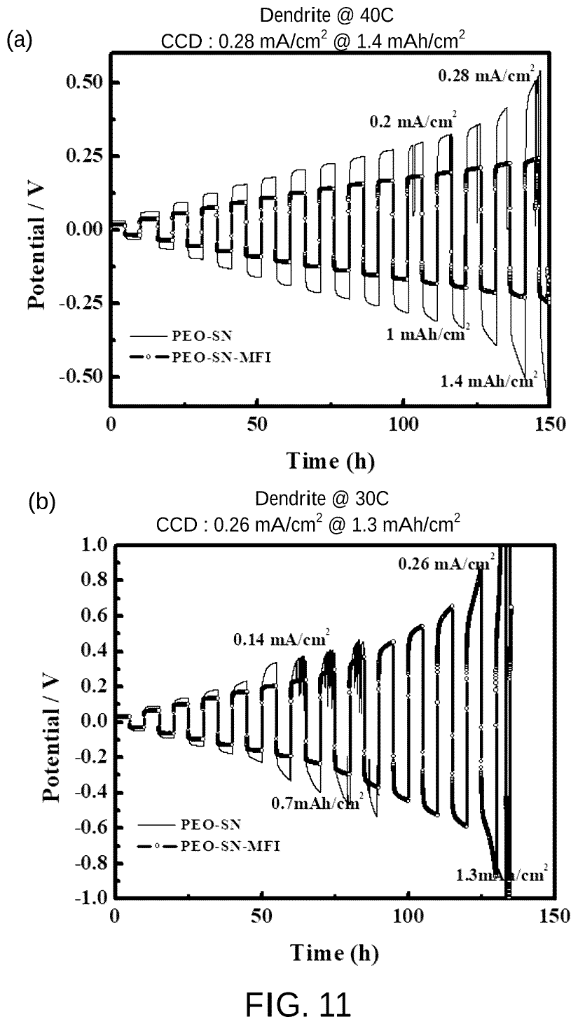

Additionally, the effectiveness of the MFI layer in preventing dendrite growth was tested, and the results showed that the MFI layer can serve as a physical barrier to contain lithium dendrites (FIG. 11).

### [Application of MFI-PEO-SN all Polymer Solid-Electrolyte]

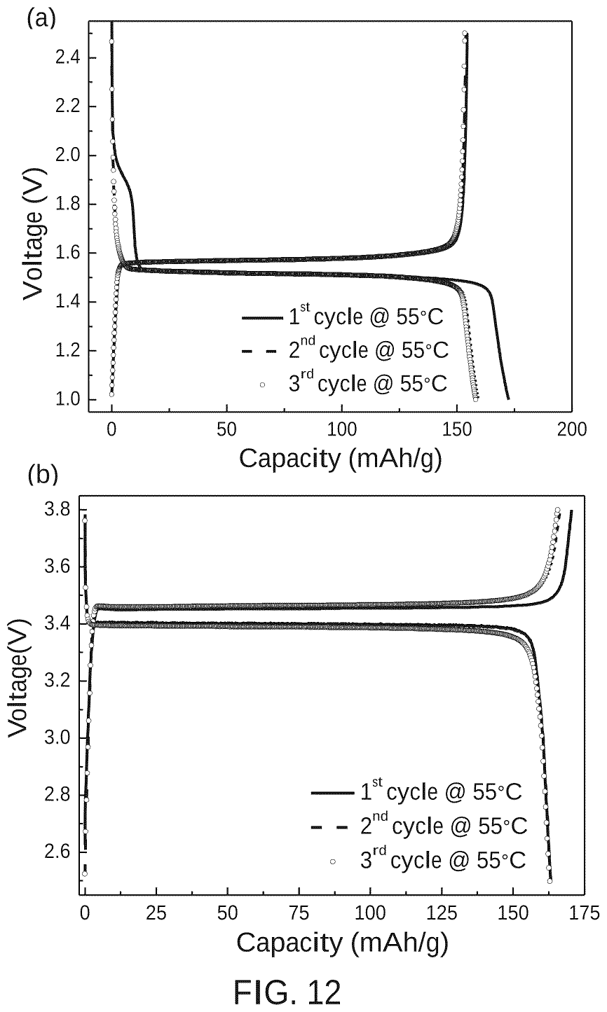

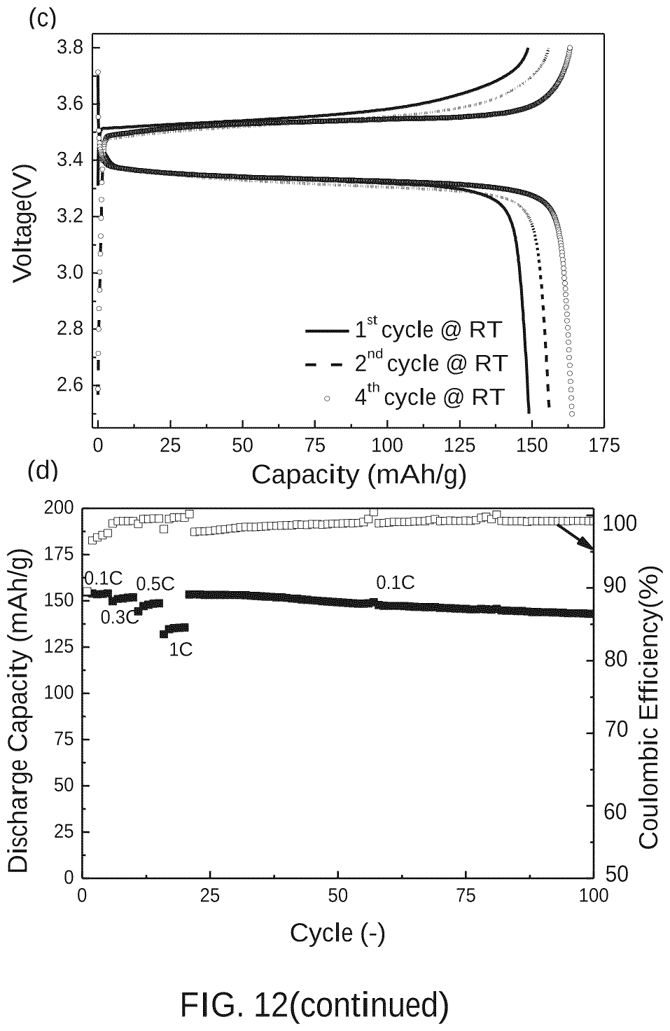

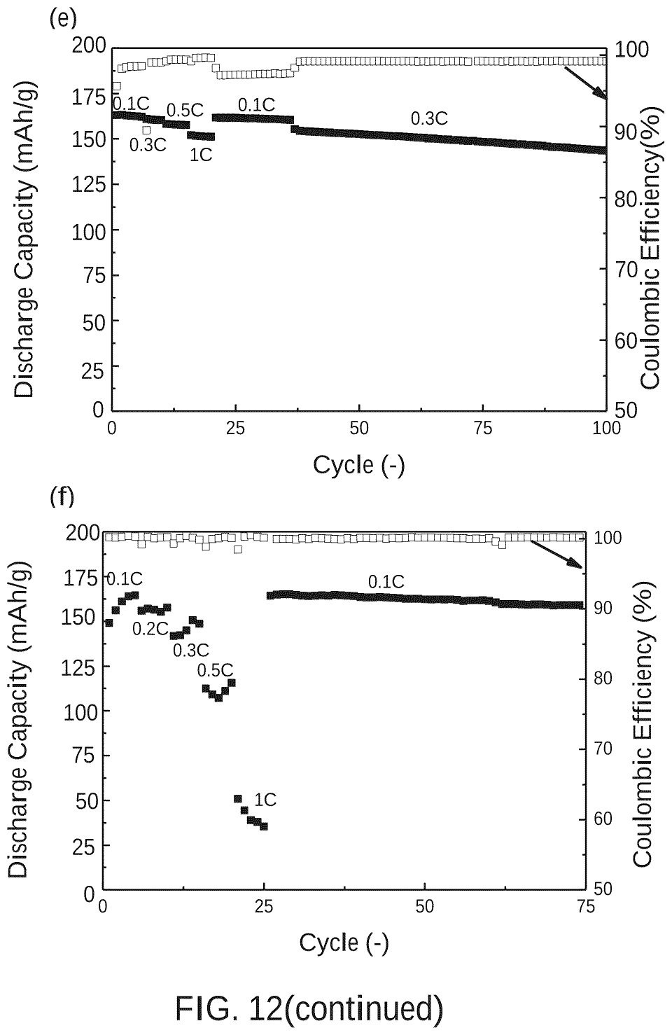

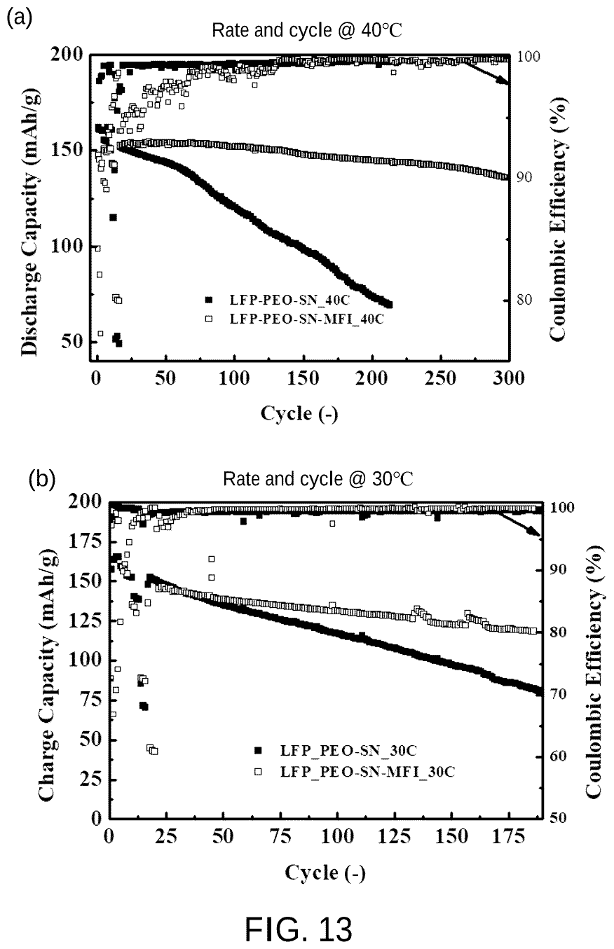

The application of MFI-PEO-SN solid electrolyte was tested by assembling coin cells with LTO and LFP electrodes paired with lithium (FIG. 12). The capacities of LTO and LFP were 154 and 163 mAh/g, respectively, at 55° C., close to these materials' capacities with liquid electrolyte systems reported elsewhere. There was no significant increase in overpotential observed compared with liquid electrolyte systems. LTO and LFP can hold 88% and 93% of their capacity at 1 C, with 93% and 86% retention after 100 cycles, respectively. The stability of these electrodes is remarkable at high operational temperatures considering the temperature-dependent reactivity of SN molecules with lithium, proving that the interfacial layer effect is not short-lived but can hold its performance over a period of time. Charge-discharge plateau of LFP showed an increase in overpotential of 0.1 V at RT compared with 55° C. performance. LFP capacity was 163 mAh/g, the same as 55° C. operations, but it took four cycles to reach this value indicating the difference in lithium-ion diffusion at a lower temperature. This slow diffusion was witnessed in rate performance, and there was a considerable drop in capacity at high C-rates. Despite slow diffusion at RT, the coulombic efficiency was 100% right from the first cycle, but it was relatively less when the cell operated at 55° C., particularly at a slower 0.1 C rate. This drop in coulombic efficiency could be due to the possible reaction between cathode material and PEO when potential and temperature are kept high since there is no protection layer, again stressing the need for a double side protection layer to improve the performance further. The capacity retention of the LFP cathode at RT was 97% after 74 cycles, proving that there was no loss of lithium since there was no side reactions and the interfacial layer development is successful with potential practical application. Also, the stable performance of MFI-PEO-SN solid electrolyte for 300 cycles at 40° C. (FIG. 13a) and 175 cycles at 30° C. (FIG. 13b) was proved.

### CONCLUSIONS

A gel polymer infused nanofibrous hybrid interfacial layer is developed that provides mechanical strength to prepare processable PEO-SN based all polymer electrolyte membranes with <100 μm thickness while maintaining SN:EO ratio above 1:6. Innovative integration of FEC molecules into the membrane without compromising mechanical property allowed in-situ formation of an interfacial layer on lithium. The heating of this membrane leads to the diffusion of FEC molecule to the lithium surface and the mixing of PEO-SN electrolyte with PEO-LiClO₄ trapped inside the nanofibrous mat. The operational mechanism of the membrane was proved using impedance analysis by heat-treating the membrane systematically. LSV analysis of these membranes integrated with lithium, LTO, and LFP materials revealed that the SN reaction with lithium is temperature dependent and high effectiveness of the interfacial layer in preventing this reaction. Coin cells made with LTO and LFP electrodes combined with the newly developed membranes showed remarkable stability at high and room temperatures. A multi-functional interfacial layer is successfully developed that acts as a host for FEC molecules, provides mechanical strength to prepare a thin processable polymer solid-electrolyte membrane, prevents SN reaction with lithium, and has the potential to apply for practical industrial application.

What is claimed is:

1. A solid-state battery, comprising:
a first electrode;
a second electrode; and
a composite membrane sandwiched between the first electrode and the second electrode and including a first multifunctional interfacial layer and a plasticizer-containing electrolyte,
wherein the first multifunctional interfacial layer includes a first conducting fiber network and a first polymer-based conductive medium infused into porous areas of the first conducting fiber network and adjacent to the first electrode,
wherein the first polymer-based conductive medium contains a first interface additive therein and serves as a first conductive gel or the first interface additive diffuses from the first polymer-based conductive medium to form a first in-situ interfacial layer between the first electrode and the first polymer-based conductive medium, and
wherein the plasticizer-containing electrolyte is combined with the first conducting fiber network and spaced from the first electrode by the first multifunctional interfacial layer.

2. The solid-state battery of claim 1, wherein the composite membrane further includes a second multifunctional interfacial layer, wherein:
the second multifunctional interfacial layer includes a second conducting fiber network and a second polymer-based conductive medium infused into porous areas of the second conducting fiber network and adjacent to the second electrode,
the second polymer-based conductive medium contains a second interface additive therein and serves as a second conductive gel or the second interface additive diffuses from the second polymer-based conductive medium to form a second in-situ interfacial layer between the second electrode and the second polymer-based conductive medium, and
the plasticizer-containing electrolyte is combined with the second conducting fiber network and spaced from the second electrode by the second multifunctional interfacial layer.

3. The solid-state battery of claim 1, wherein the first conducting fiber network includes a first conductive polymer and first stiffeners as constituents thereof.

4. The solid-state battery of claim 3, wherein the first stiffeners are multi-walled carbon nanotubes.

5. The solid-state battery of claim 3, wherein the first conductive polymer includes an ionic-electric dual-conductive polymer and an ionic conductive polymer.

6. The solid-state battery of claim 5, wherein the ionic-electric dual-conductive polymer is PEDOT:PSS copolymer.

7. The solid-state battery of claim 5, wherein the ionic conductive polymer is PEO polymer, a PVDF polymer or a combination thereof.

8. The solid-state battery of claim 3, wherein the first conducting fiber network further includes a first binder.

9. The solid-state battery of claim 1, wherein the first polymer-based conductive medium includes an ionic conductive polymer and lithium salts.

10. The solid-state battery of claim 9, wherein the ionic conductive polymer is PEO polymer, a PVDF polymer or a combination thereof.

11. The solid-state battery of claim 1, wherein the first in-situ interfacial layer is formed by oxidation of the first interface additive.

12. The solid-state battery of claim 1, wherein the first interface additive is fluoroethylene carbonate (FEC), ethylene carbonate (EC), propylene carbonate (PC) or a combination thereof.

13. The solid-state battery of claim 2, wherein the second conducting fiber network includes a second conductive polymer and second stiffeners as constituents thereof.

14. The solid-state battery of claim 13, wherein the second stiffeners are multi-walled carbon nanotubes.

15. The solid-state battery of claim 13, wherein the second conductive polymer includes an ionic-electric dual-conductive polymer and an ionic conductive polymer.

16. The solid-state battery of claim 15, wherein the ionic-electric dual-conductive polymer is PEDOT:PSS copolymer.

17. The solid-state battery of claim 15, wherein the ionic conductive polymer is PEO polymer, a PVDF polymer or a combination thereof.

18. The solid-state battery of claim 13, wherein the second conducting fiber network further includes a second binder.

19. The solid-state battery of claim 2, wherein the second polymer-based conductive medium includes an ionic conductive polymer and lithium salts.

20. The solid-state battery of claim 19, wherein the ionic conductive polymer is PEO polymer, a PVDF polymer or a combination thereof.

21. The solid-state battery of claim 2, wherein the second in-situ interfacial layer is formed by oxidation of the second interface additive.

22. The solid-state battery of claim 2, wherein the second interface additive is fluoroethylene carbonate (FEC), ethylene carbonate (EC), propylene carbonate (PC) or a combination thereof.

23. The solid-state battery of claim 1, wherein the plasticizer-containing electrolyte includes a solid-state electrolyte matrix and a plasticizer in the solid-state electrolyte matrix.

24. The solid-state battery of claim 23, wherein the plasticizer is succinonitrile.

25. The solid-state battery of claim 1, wherein the first conducting fiber network has a thickness of from 0.1 to 10 μm.

26. The solid-state battery of claim 1, wherein the first polymer-based conductive medium has a thickness of from 0.01 to 5 μm.

27. The solid-state battery of claim 2, wherein the second conducting fiber network has a thickness of from 0.1 to 10 μm.

28. The solid-state battery of claim 2, wherein the second polymer-based conductive medium has a thickness of from 0.01 to 5 μm.

29. A multifunctional interfacial layer, comprising:
a conducting fiber network; and
a polymer-based conductive medium infused into porous areas of the conducting fiber network, wherein the polymer-based conductive medium contains an interface additive therein and serves as a conductive gel.

30. The multifunctional interfacial layer of claim 29, wherein the conducting fiber network includes a conductive polymer and stiffeners as constituents thereof.

31. The multifunctional interfacial layer of claim 30, wherein the stiffeners are multi-walled carbon nanotubes.

32. The multifunctional interfacial layer of claim 30, wherein the conductive polymer includes an ionic-electric dual-conductive polymer and an ionic conductive polymer.

33. The multifunctional interfacial layer of claim 32, wherein the ionic-electric dual-conductive polymer is PEDOT:PSS copolymer.

34. The multifunctional interfacial layer of claim 32, wherein the ionic conductive polymer is PEO polymer, a PVDF polymer or a combination thereof.

35. The multifunctional interfacial layer of claim 30, wherein the conducting fiber network further includes a binder.

36. The multifunctional interfacial layer of claim 29, wherein the polymer-based conductive medium includes an ionic conductive polymer and lithium salts.

37. The multifunctional interfacial layer of claim 36, wherein the ionic conductive polymer is PEO polymer, a PVDF polymer or a combination thereof.

38. The multifunctional interfacial layer of claim 29, wherein the interface additive is fluoroethylene carbonate (FEC), ethylene carbonate (EC), propylene carbonate (PC) or a combination thereof.

39. A composite membrane, comprising a first multifunctional interfacial layer and a plasticizer-containing electrolyte, wherein:
the first multifunctional interfacial layer includes a first conducting fiber network and a first polymer-based conductive medium infused into porous areas of the first conducting fiber network from a first side of the first conducting fiber network;
the plasticizer-containing electrolyte is combined with the first conducting fiber network from a second side of the first conducting fiber network opposite to the first side; and
the first polymer-based conductive medium contains a first interface additive therein and serves as a first conductive gel.

40. The composite membrane of claim 39, further comprising a second multifunctional interfacial layer, wherein:
the second multifunctional interfacial layer includes a second conducting fiber network and a second polymer-based conductive medium;
the plasticizer-containing electrolyte is combined with the second conducting fiber network from a first side of the second conducting fiber network; and
the second polymer-based conductive medium contains a second interface additive therein and serves as a second conductive gel infused into porous areas of the second conducting fiber network from a second side of the second conducting fiber network opposite to the first side.

41. The composite membrane of claim 39, wherein the first conducting fiber network includes a first conductive polymer and first stiffeners as constituents thereof.

42. The composite membrane of claim 41, wherein the first stiffeners are multi-walled carbon nanotubes.

43. The composite membrane of claim 41, wherein the first conductive polymer includes an ionic-electric dual-conductive polymer and an ionic conductive polymer.

44. The composite membrane of claim 44, wherein the ionic-electric dual-conductive polymer is PEDOT:PSS copolymer.

45. The composite membrane of claim 44, wherein the ionic conductive polymer is PEO polymer, a PVDF polymer or a combination thereof.

46. The composite membrane of claim 41, wherein the first conducting fiber network further includes a first binder.

47. The composite membrane of claim 39, wherein the first polymer-based conductive medium includes an ionic conductive polymer and lithium salts.

48. The composite membrane of claim 47, wherein the ionic conductive polymer is PEO polymer, a PVDF polymer or a combination thereof.

49. The composite membrane of claim 39, wherein the first interface additive is fluoroethylene carbonate (FEC), ethylene carbonate (EC), propylene carbonate (PC) or a combination thereof.

50. The composite membrane of claim 40, wherein the second conducting fiber network includes a second conductive polymer and second stiffeners as constituents thereof.

51. The composite membrane of claim 50, wherein the second stiffeners are multi-walled carbon nanotubes.

52. The composite membrane of claim 50, wherein the second conductive polymer includes an ionic-electric dual-conductive polymer and an ionic conductive polymer.

53. The composite membrane of claim 52, wherein the ionic-electric dual-conductive polymer is PEDOT:PSS copolymer.

54. The composite membrane of claim 52, wherein the ionic conductive polymer is PEO polymer, a PVDF polymer or a combination thereof.

55. The composite membrane of claim 50, wherein the second conducting fiber network further includes a second binder.

56. The composite membrane of claim 40, wherein the second polymer-based conductive medium includes an ionic conductive polymer and lithium salts.

57. The composite membrane of claim 56, wherein the ionic conductive polymer is PEO polymer, a PVDF polymer or a combination thereof.

58. The composite membrane of claim 40, wherein the second interface additive is fluoroethylene carbonate (FEC), ethylene carbonate (EC), propylene carbonate (PC) or a combination thereof.

59. The composite membrane of claim 39, wherein the plasticizer-containing electrolyte includes a solid-state electrolyte matrix and a plasticizer in the solid-state electrolyte matrix.

60. The composite membrane of claim 59, wherein the plasticizer is succinonitrile.

61. The composite membrane of claim 39, wherein the first conducting fiber network has a thickness of from 0.1 to 10 μm.

62. The composite membrane of claim 39, wherein the first polymer-based conductive medium has a thickness of from 0.01 to 5 μm.

63. The composite membrane of claim 40, wherein the second conducting fiber network has a thickness of from 0.1 to 10 μm.

64. The composite membrane of claim 40, wherein the second polymer-based conductive medium has a thickness of from 0.01 to 5 μm.
